(19) United States
(12) Patent Application Publication
(10) Pub. No.: US 2025/0377233 A1
(43) Pub. Date: Dec. 11, 2025

(54) METHOD FOR MONITORING THE STRUCTURE OF A HOUSING STRUCTURE

(71) Applicant: HELLA GmbH & Co. KGaA, Lippstadt (DE)

(72) Inventors: Thomas NIEMANN, Delmenhorst (DE); Hauke BAUMGÄRTEL, Ganderkesee (DE)

(21) Appl. No.: 19/231,107

(22) Filed: Jun. 6, 2025

(30) Foreign Application Priority Data
Jun. 6, 2024 (DE) 102024115872.7
May 19, 2025 (DE) 102025119298.7

(51) Int. Cl. G01F 23/296; G01F 23/80

(52) U.S. Cl. CPC G01F 23/296; G01F 23/80

(57) ABSTRACT

In a method for monitoring the structure of a housing structure, the housing structure is connected to at least one sensor assembly in a manner conductive of structure-borne sound signals. The sensor assembly includes at least one structure-borne sound sensor for detecting structure-borne sound signals propagating on the housing structure. The housing structure includes at least one signal emitter, and the at least one signal emitter is embedded in at least one wall of the housing structure. The at least one signal emitter is designed to emit and/or to influence structure-borne sound signals propagating on the housing structure. A structure-borne sound signal which is emitted and/or influenced by the signal emitters and propagates on the housing structure is captured by means of the sensor assembly. The structure-borne sound signal captured by means of the sensor assembly is evaluated in order to evaluate the status of the housing structure.

### FIELD OF THE INVENTION

The invention relates to a method for monitoring the structure of a housing structure. Further aspects of the invention relate to a housing structure and a motor vehicle.

### BACKGROUND

A housing structure of such kind may be for example the fuel tank of a motor vehicle. In particular it may relate to a hydrogen tank. However, the housing structure may also be a battery cover or a battery housing in a motor vehicle. The housing structure may include an outer casing with a wall made from a fibre-reinforced plastic, for example from glass fibre-reinforced plastic or carbon fibre-reinforced plastic. For example, in the case of a hydrogen tank, the housing structure may have an inner, gas-impermeable casing, made from PTFE for example, in which the fluid medium is contained. Even if such materials are suitable for long-term operation, in a motor vehicle for example, material fatigue effects or even damage events can still cause deterioration of the housing structure. In the case of a hydrogen tank, hydrogen may be able to escape as a consequence of damage, for example, which then represents a serious hazard potential. In order to detect such hazard potentials early, hydrogen leak sensors are known, for example, by which a hydrogen leak can be detected. These may involve detecting fractions of hydrogen in the ambient air, for example. The drawback with this method is that a warning can only be output as soon as a hydrogen leak has actually occurred.

In electric vehicles, high-voltage batteries are used in which the energy needed to supply the electric propulsion is stored. A preferred installation location for high-voltage batteries in the vehicle is the underbody area. Here, the battery can be shielded with an underbody cover to protect it from the external influences. It is possible that damage to the high-voltage battery can lead to secondary damage or even create a threat to persons in the vicinity or inside the vehicle. In order to detect damage to the battery, battery management systems are known. However, such systems are associated with a possible problem in that damage to the battery cells is not detected by the batter management system until such damage is too far advanced and secondary damage is no longer preventable. Damage may be caused for example by mechanical effects, if the vehicle bottoms out when driving, for example.

### SUMMARY

The object underlying the invention is to suggest a method for monitoring the structure of a housing structure, which makes it possible to detect possible damage in the housing structure before a medium contained in said structure leaks out, and/or before a battery covered thereby is damaged.

This object is solved with a method and with a housing structure having the features of the claims.

A method for monitoring the structure of a housing structure, wherein the housing structure is connected to at least one sensor assembly in a manner conductive of structure-borne sound signals, wherein the sensor assembly includes at least one structure-borne sound sensor for detecting structure-borne sound signals propagating in and on the housing structure, wherein the housing structure includes at least one signal emitter, wherein the at least one signal emitter is embedded in at least one wall of the housing structure, wherein the at least one signal emitter is designed to emit and/or to influence structure-borne sound signals propagating in and on the housing structure, wherein a structure-borne sound signal which is emitted and/or influenced by the signal emitters and propagates in and on the housing structure is detected by means of the sensor assembly, and wherein the structure-borne sound signal captured by means of the sensor assembly is evaluated in order to evaluate the condition of the housing structure is provided as essential to the invention.

The housing structure may be in particular a tank, a hydrogen tank for example. A hydrogen tank may include an outer casing and a gas-impermeable inner casing surrounded by the outer casing. In such case, a wall, in particular the outer casing of the housing structure, may be manufactured from a fibre-reinforced composite material. When this housing structure is filled with in particular a fluid medium, for example with hydrogen, the housing structure, in particular the inner casing and therewith also the outer casing may be expanded, so that structure-borne sound signals may be excited in and on the outer casing. In order to capture structure-borne sound signals, structure-borne sound sensors with piezoelectric elements may be used, for example. Additionally, the housing structure may be stimulated to create vibrations as it is filled or emptied, which vibrations propagate in and on the housing structure in the form of structure-borne sound vibrations. The housing structure may also be the cover of a battery of a motor vehicle, in particular an electric vehicle. This may be arranged in the floor area of the vehicle, for example. The propagating structure-borne sound may be captured by means of at least one structure-borne sound sensor, which is connected to the housing structure in such manner as to conduct structure-borne sound. At least one signal emitter is embedded in at least one wall of the housing structure. Preferably, a multiplicity of signal emitters are embedded. A signal emitter may be for example a fibre, such as for example a glass fibre, a carbon fibre, a glass bead, a plastic bead, or also an acoustic fibre. Preferably, a multiplicity of signal emitters are embedded in even distribution or at certain positions in the wall of the housing structure. For example, said signal emitters may be laminated into the material of the outer casing, that is to say into the fibre-reinforced composite material of the outer casing. In such a context, the signal emitter function in particular as acoustic signal emitters. Structure-borne sound signals propagating in and on the housing structure can be produced and influenced, in particular amplified, by the acoustic signal emitters. For example, the propagating structure-borne sound signals can be influenced by a change in the structure of the housing structure via the embedded signal emitters. This yields an improved signal-to-noise ratio, thereby enabling reliable detection of damage to the housing structure by means of the structure-borne sound sensor system. Structure-borne sound signals propagating in and on the housing structure may preferably be generated by the signal emitters, so that they can be detected more easily. This can happen for example when the housing structure expands and contracts due to changes in the filling state, or also as a result of changes in the housing structure due to damage. In such a case, the properties of the signal emitter fibres may be chosen such that they react to a load on the housing structure before the fibres that make up the housing structure. For example, the signal emitter fibres may react more sensitively to loads than the fibres that constitute the housing structure, and in so doing emit characteristic structure-borne sound signal patterns before the structure fibres. The structure-borne sound signal patterns emitted by the signal emitter fibres can be captured before the fibres forming the housing structure are entrained. Characteristic structure-borne sound signal patterns that indicate contacts of the housing structure by a foreign object or impacts can also be captured and analysed. When used in a battery cover, structure-borne sound signal patterns that indicate damage to the battery can be captured in particular.

In a further development of the method, the housing structure is designed to hold fluid or solid media, and a structure-borne sound signal that is influenced and/or produced by the signal emitters and propagates in and on the housing structure at a known fill level of the housing structure is captured and stored as reference value. The housing structure may in particular be a tank, for example a hydrogen tank, with an outer casing and an inner casing. For a known fill level of the housing structure, for example when the housing structure is completely full or half full, characteristic structure-borne sound signals propagating in and on the housing structure can be captured by means of the structure-borne sound sensor. The structure-borne sound signals propagating in and on the housing structure can be influenced and in particular produced by the signal emitter fibres, so that the structure-borne sound signals are clearly distinguished from a background noise. A recorded structure-borne sound signal at a defined fill level may be stored as reference signal, in particular in an electronic storage device. By capturing the structure-borne sound signals for certain fill levels of the housing structure and comparing these with the reference signal, it is possible to draw a conclusion about the change in status, for example damage to the housing structure. Moreover, characteristic structure-borne sound signal patterns that indicate contact of the housing structure by a foreign object can be captured and analysed with respect to their hazard potential.

In a filling operation of the housing structure, for example during initial filling of the housing structure or also at recurring intervals, structure-borne sound signals propagating in and on the housing structure can be captured and stored as reference signals. In such as case, the structure-borne sound signals may be logged depending on the respective fill status. The structure-borne sound signals that propagate in and on the housing structure during filling, for example because of the expansion of the housing structure, can be recorded and compared with the reference signals during operation. Differences between the currently logged structure-borne sound signals and the stored reference signals suggest that there have been changes to the housing structure. For example, during operation of a motor vehicle in which the hydrogen tank is being emptied, and the pressure inside the tank is therefore falling, the resulting propagating structure-borne sound signals can be captured and compared with reference values. A conclusion regarding damage to the housing structure, for example, can be drawn from changes with respect to the reference value.

In one embodiment of the invention, the housing structure is a battery cover in a motor vehicle. In order to detect damage to the battery and/or the underbody cover of a motor vehicle early, at least one, preferably multiple structure-borne sound sensors are arranged on the underbody cover, by which vibrations propagating in and on the underbody cover can be captured. The structure-borne sound sensor may include a piezoelectric element, for example. The vibrations may be in particular the vibrations produced while travelling by a contact event such as when the vehicle underbody bottoms out. Certain damage events to the underbody cover, for example breakage of the underbody cover, produce characteristic structure-borne sound signal patterns. When a corresponding structure-borne sound signal pattern is captured by a structure-borne sound sensor, it is consequently possible to infer the occurrence of the corresponding damage event. The signal emitters can contribute to the generation and distinguishability of the structure-borne sound signal patterns, so that a reliable distinction can be made between different damage events. The signal emitters may also generate structure-borne sound signal patterns for critical states of the battery, which can be captured. For example, the signal emitters may generate cracking noises or structure-borne sound signal patterns in the event of fractures of the housing structure or also if the housing structure is exposed to heavy impacts, and these can be captured easily.

In a further development of the method, characteristic structure-borne sound signal patterns are emitted by the signal emitters in the event of critical states of the housing structure, and when a characteristic structure-borne sound signal pattern is detected, a conclusion is drawn regarding the critical state of the housing structure. For example, with a housing structure embodied as a tank, a structure-borne sound signal may be produced by the acoustic signal emitters during a filling operation, that is to say when the wall of the housing structure is expanded. For example, a kind of cracking or similar may be produced when an acoustic transduce in the form of an acoustic fibre is stretched or extended, and this is then captured by the structure-borne sound sensor system. In particular, the signal emitter fibres may be designed such that they produce corresponding structure-borne sound signals earlier than the fibres that form the housing structure under load. When such a characteristic structure-borne sound signal pattern arises, a critical state of the housing structure can be inferred, for example the tank may burst soon and refuelling must be discontinued. In this way, damage to the fibres that form the housing structure can be avoided. Signal emitters in the form of plastic beads or glass beads can also create structure-borne sound signals for various filling statuses or in event of a change in the filling status. The introduction of the acoustic signal emitters thus enables characteristic structure-borne sound signal patterns to be created in the event of changes in the filling status of the housing structure, which can be captured easily by the structure-borne sound sensor. When the housing structure is embodied as a battery cover as well, the signal emitters can produce structure-borne sound signal patterns for critical statuses of the battery, which can be captured. For example, the signal emitters can produce cracking noises or structure-borne sound signal patterns, for example, if the housing structure is fractured or also if the housing structure suffers heavy impacts, and these too can easily be captured. In particular, the signal emitter fibres in such a case may be designed in such a way that they break sooner than the structure fibres. The breaking signal emitter fibres can be detected on the basis of the emitted structure-borne sound signals, and measures can be undertaken before the structure fibres break as well or are damaged in some other way.

In a preferred embodiment of the invention, at least one recorded structure- borne sound signal is compared with at least one reference value, and if deviations are detected a warning signal is emitted. In order to determine the status of the housing structure, the structure-borne sound signals that are currently propagating in and on the housing structure and have been captured via the structure-borne sound sensor system are compared with stored reference values. Deviations may indicate that the housing structure has been changed, for example suffered damage. When deviations occur, a warning signal can be output, for a driver of the vehicle, for example, or a fault message can be stored in the onboard electronics, so that early corrective measures can be initiated, before more dangerous damage to the housing structure occurs, with a higher hazard potential. Optionally, a warning signal advising that the vehicle be switched off immediately can also be output.

In a further development of the method, the characteristic structure-borne sound signal patterns produced and/or influenced by the signal emitters are filtered out of a background noise. Characteristic structure-borne sound signal patterns are produced by the acoustic signal emitters, or the structure-borne sound signals propagating on the housing structure are influenced correspondingly by the acoustic signal emitters. Influencing of the propagating structure-borne sound signals may be induced for example by the signal emitters embedded in the material due to a structural change in the housing structure. In this way, the structure-borne sound signal patterns influenced by the acoustic signal emitters can easily be differentiated so that they can simply be filtered out of a background noise.

In a preferred further development of the method, the signal emitters are fibres, and the fibres consist of an at least similar, in particular the same material as the fibres from which the housing structure is made from. The housing structure may consist of a fibre-reinforced plastic, in particular carbon fibre-reinforced composite material or glass fibre-reinforced plastic, or also another material. The signal emitters are preferably fibres of the kind from which the housing structure was constructed. Accordingly, with a housing structure made from glass fibre-reinforced plastic the signal emitters may be made of glass fibres, and with a housing structure made from carbon fibre-reinforced plastic the signal emitters may be made of carbon fibres. When the same material is selected for the signal emitter fibres and the structure-forming fibres, the fibre structure of the housing structure is not disrupted. No defect sites are created in the housing structure by the signal emitter fibres, so the stability of the housing structure is preserved. The signal emitter fibres preferably have slightly different material properties from the fibres that make up the housing structure. In particular, the material properties may be chosen such that the signal emitter fibres emit structure-borne sound signals indicate signs of damage such as breakage of the fibre before the other fibres in the event of critical statuses of the housing structure. Such signs of damage may be detected early by via the structure-borne sound sensor system, before the structure-forming fibres break and the housing structure is damaged.

In a preferred further development of the method, the fibres that form the signal emitters have a lower tensile strength and/or a higher tensile E-Modul and/or a lower strain at failure. The tensile strength is understood to mean the maximum force in the direction of the fibre that the material is able to withstand under load before it breaks. If the signal emitter fibres have a lower tensile strength than that of the structure-forming fibres, it can be assumed that the signal emitter fibres will break or be damaged before the structure-forming fibres when a load is applied to the housing structure. The damage to the individual signal emitter fibres can be detected early by means of the structure-borne sound signal sensor system, and corresponding countermeasures can be implemented to prevent damage to the fibres that form the housing structure. The strain at failure describes the maximum proportional change in length of the material before it tears or breaks under tensile load. The strain at failure is a measure of the ductility of the material. A lower strain at failure of the signal emitter fibres also ensures an early, detectable failure of the signal fibres, before the structure-forming fibres tear. The tensile E-Modul describes the rigidity of a material, that is to say the ratio of load and expansion in the elastic range.

In a further development of the method, the signal emitters are glass fibres and/or carbon fibres and/or glass beads and/or plastic beads and/or acoustic fibres. The structure-borne sound signals propagating in and on the housing structure can be influenced by the acoustic signal emitters. In particular, in this context both individual fibres and acoustic signal emitters may be provided, but fibre composites may also be used as signal emitters. Acoustic fibres may also produce characteristic acoustic signals, in particular structure-borne sound signals, and/or signal first detectable signs of failure before the structure-forming fibres when the fibres are stretched, for example.

In a further development of the method, the sensor assembly includes at least a central control unit and at least one transmitter unit, the central control unit and the at least one transmitter unit are designed to produce and receive structure-borne sound signal patterns, at least one structure-borne sound signal pattern is transmitted by means of the transmitter unit, the structure-borne sound signal pattern transmitted by the transmitter unit is received and evaluated by means of the central control unit, and a conclusion is drawn about the status of the housing structure from the received structure-borne sound signal pattern.

A sensor assembly with a central control unit and multiple transmitter units may be used in the method. The central control unit and the transmitter units are designed to produce and receive structure-borne sound signal patterns. In this context, structure-borne sound signal patterns that propagate in and on the housing structure, in particular the tank to be monitored can be captured. Structure-borne sound signal patterns produced can also be monitored and evaluated actively by the central control unit and the transmitter units. Structure-borne sound signal patterns are generated with a piezoelectric element for example, by means of at least one transmitter unit, preferably by means of multiple transmitter units. The structure-borne sound signal pattern transmitted by the transmitter unit is received by the central control unit and evaluated by an evaluation device. A conclusion may be drawn about the status of the housing structure from the occurrence of characteristic signal patterns, characteristic frequencies, characteristic signal profiles or similar. In this context, characteristic signal patterns that are known to warn of damage to the housing structure may be stored in a storage device for comparison. Changes in the structure-borne sound signal patterns, in particular in the progression over time of the structure-borne sound signal patterns, may be captured, wherein changes in the progression over time indicate a change in the housing structure. Algorithms can be used to filter the structure-borne sound signal patterns produced out of the vibrations that arise during operation and which constitute a kind of background noise. It may further be provided that a certain structure-borne sound signal pattern is sent by a transmitter unit and is received by the central control unit, or vice versa. By comparing the known, transmitted structure-borne sound signal pattern with the structure-borne sound signal pattern received by the central control unit, a conclusion may be drawn about the status of the housing structure. For example, the structure-borne sound signal pattern may be altered on its transmission path between the transmitter unit and the central control unit by damage to the housing structure, and said damage is detectable because of this alteration. It may be easier to detect alterations that indicate damage through the signal emitters, since corresponding characteristic structure-borne sound signal patterns can be produced by the signal emitters, for example. Thus, early detection of damage to the housing structure is possible, before any of the fluid medium held therein can leak out.

In a further development of the method, control commands in the form of structure-borne sound signal patterns are generated by the central control unit and sent to the transmitter units. Digital or analogue encoded control commands may be sent by the central control unit to the transmitter units in the form of structure-borne sound signal patterns, for example by wavelets, standing waves, chirps or the like. In this way, for example, the transmitter units may be actuated to generate certain structure-borne sound signal patterns or the like. Signal transmission between the central control unit and the transmitter units via structure-borne sound signals means that no extra data lines or the like need to be installed, and the sensor assembly can be arranged in the housing structure inexpensively.

A further aspect of the invention relates to a housing structure with at least one wall, wherein at least one signal emitter is embedded in the wall, and wherein the at least one signal emitter is designed to emit and/or influence structure-borne sound signals propagating in and on the housing structure. The housing structure may be in particular a fuel tank for a motor vehicle. For example, it may be a tank for holding hydrogen. The housing structure may have at least one wall. The wall may be an outer casing. In the case of a hydrogen tank, the outer casing may also surround a gas-impermeable inner casing. Moreover, the housing structure may further function as the cover of a vehicle battery. In this context, the housing structure may be made from a fibre-reinforced plastic, in particular carbon fibre-reinforced composite material or glass fibre-reinforced plastic, or also from another material. At least one signal emitter, preferably multiple acoustic signal emitters, is/are embedded in the wall. For this purpose, the at least one signal emitter, preferably multiple signal emitter fibres may be worked into the material as well when the casing layer is manufactured. For example, the signal emitters may be cast, laminated, pressed or similarly worked into the casing layer at the same time. Particularly under load, the acoustic signal emitters produce characteristic structure-borne sound signal patterns, or the structure-borne sound signals propagating in and on the housing structure are influenced correspondingly by the acoustic signal emitter. In this context, the influencing of the propagating structure-borne sound signals may be induced by the signal emitters for example by a change in the structure of the wall. This allows the structure-borne sound signal patterns influenced by the acoustic signal emitters to be differentiated easily so that they can simply be filtered out of a background noise. However, the signal emitter fibres are preferably made from the same material as the structure-forming fibres so that no defect sites are created in the housing structure. The signal emitter fibres may be designed such that they indicate signs of damage such as breakage of the fibre before the structure-forming fibres when loads are applied to the housing structure. These signs of damage may be detected early by means of the structure-borne sound sensor system, before the structure-forming fibres break as well and the housing structure suffers damage.

In a further development of the invention, the housing structure includes at least one sensor apparatus for detecting structure-borne sound signals propagating in and on the housing structure that are influenced and/or produced by the signal emitters. In order to capture the structure-borne sound signals propagating in and on the housing structure, the housing structure is equipped with at least one sensor apparatus. The sensor apparatus in such a case is connected to the housing casing that accommodates the signal emitters in a manner conductive of structure-borne sound signals. The structure-borne sound sensor may be a piezoelectric element for example. For the evaluation, the sensor apparatus may include an evaluation device, for example a microprocessor or the like, or the sensor apparatus may be connected to an evaluation device by signalling means. The sensor apparatus enables the capture of structure-borne sound signals that have been influenced by the signal emitters. Characteristic signal patterns can also be generated by the acoustic signal emitters and may be detected precisely by the sensor apparatus and filtered out of a background noise. For example, when refilling a housing structure embodied as a tank, characteristic signal patterns may be produced as the tank expands, and these are captured correspondingly by the sensor apparatus. If deviations arise from the expected structure-borne sound signal patterns or during the detection of signal patterns which indicate damage to the housing structure, corresponding measures can be implemented.

In a further development of the invention, at least one wall is made from a fibre-reinforced composite material. In particular, the outer casing of the housing structure may be made from a carbon fibre-reinforced plastic or a glass fibre-reinforced plastic. The acoustic signal emitters can be worked into these composite materials particularly easily, to detect an expansion of the housing structure, during refuelling for example.

In a preferred further development of the invention, the signal emitters are fibres and the fibres consist of an at least similar, in particular of the same material as the fibres from which the housing structure was manufactured. The housing structure may be made from a fibre-reinforced plastic, in particular from carbon fibre-reinforced plastic or glass fibre-reinforced plastic, or also from a different material. The signal emitters are preferably fibres of the kind from which the housing structure has been constructed. Accordingly, for a housing structure made from glass fibre-reinforced plastic the signal emitters may be of glass fibres and for a housing structure made from carbon fibre-reinforced plastic the signal emitters may be of carbon fibres. When the same material is selected for the signal emitter fibres and the structure-forming fibres, the fibre structure of the housing structure is not disrupted. No defect sites are created in the housing structure by the signal emitter fibres. In such a case, the signal emitter fibres preferably have slightly different material properties from the fibres that make up the housing structure. In particular, the material properties may be chosen such that the in critical states of the housing structure the signal emitter fibres indicate signs of failure such as breakage before the structure-forming fibres, so that said signs of failure can be detected early by the structure-borne sound sensor system, before the structure-forming fibres also break and the housing structure suffers damage.

In a preferred further development of the method, the fibres that form the signal emitters have a lower tensile strength and/or a higher tensile E-Modul and/or a lower strain at failure. The tensile strength is understood to mean the maximum force in the direction of the fibre that the material is able to withstand under load before it breaks. If the signal emitter fibres have a lower tensile strength than that of the structure- forming fibres, it can be assumed that the signal emitter fibres will break before the structure-forming fibres when a load is applied to the housing structure. This can be detected early by means of the structure-borne sound sensor system, and corresponding countermeasures can be implemented. The strain at failure describes the maximum proportional change in length of the material before it tears or breaks under tensile load. The tensile strength is a measure of the ductility of the material. A lower strain at failure of the signal emitter fibres also ensures an early, detectable failure of the fibres, before the structure-forming fibres tear. The tensile E-Modul describes the rigidity of a material, that is to say the ratio of load and expansion in the elastic range.

In a further development of the invention, the signal emitters are glass fibres and/or carbon fibres and/or glass beads and/or plastic beads and/or acoustic fibres. The acoustic signal emitter can influence the structure-borne sound signals propagating in and on the housing structure. In this situation in particular, both individual fibres and acoustic signal emitters may be provided, and fibre composites may also be used as signal emitters. When an acoustic signal emitter in the form of a fibre is stretched, for example, a kind of cracking can be produced, which is then detected by the structure-borne sound sensor system. Stretching may occur for example when a battery cover is damaged or when a tank is being refilled. Plastic beads or glass beads can also induce structure-borne sound signals for various statuses or in the event of a change of the status of the housing structure. Thus, by the introduction of the acoustic signal emitters characteristic structure-borne sound signal patterns can be produced in the event of changes in the status of the housing structure, which can be detected by the structure-borne sound sensors, in particular before the structure-forming fibres of the housing structure show the first detectable signs of failure.

In a further development of the invention, the sensor assembly includes a central control unit, the central control unit is designed to generate and receive structure-borne sound signal patterns, the sensor assembly includes at least one transmitter unit, the transmitter unit is located spatially apart from the central control unit, the at least one transmitter unit is designed to generate and receive structure-borne sound signal patterns, and the central control unit includes at least one evaluation device for evaluating the structure-borne sound signal patterns transmitted by the transmitter units. The sensor assembly includes a central control unit which is designed to transmit and receive structure-borne sound signal patterns. The central control unit includes a structure-borne sound sensor, with which vibrations propagating in and on the housing structure can be captured. Piezoelectric elements or the like may serve as structure-borne sound sensors, for example. Vibrations may also be generated actively by the structure-borne sound sensor, and these propagate in and on the housing structure. Besides the central control unit, the sensor assembly includes at least one, preferably multiple transmitter units. These transmitter units are arranged spatially separately from the central control unit, in particular the central control unit and the transmitter units are each individual modules arranged separately from each other. The transmitter units are designed to produce and to receive structure-borne sound signal patterns, wherein for this purpose in particular they may include a structure-borne sound sensor, in the form of a piezoelectric element for example. The central control unit and the transmitter units may be arranged in different positions on the housing structure. In particular, the central control unit may be arranged outside the housing structure, whereas the transmitter units may be arranged on the inside of the housing structure, that is to say on the side facing into the holding space. Structure-borne sound signal patterns transmitted by the transmitter units may be captured and evaluated for example by the central control unit. For the evaluation, the central control unit includes an evaluation device, for example in the form of a computing unit, a microprocessor or the like. The structure-borne sound signal patterns can be evaluated for example for characteristic properties such as characteristic frequencies, characteristic signal profiles or the like, which yield information about structure changes in the housing structure. Changes in the structure-borne sound signal patterns sent by the transmitter units can also be evaluated on the transmission path to the central control unit, or on the return path. Changes in the structure-borne sound signal patterns caused by structural changes in the housing structure may be influenced by the signal emitters, so that they can be captured more easily. Characteristic signal patterns that indicate changes in the housing structure may be stored in a data storage device, for example, for comparison purposes.

In a further development of the invention, the housing structure is designed to hold fluid or solid media. In particular, the housing structure may be a tank, for example a hydrogen tank, with an outer casing made from a fibre-reinforced plastic.

In a further development of the invention, the signal emitter-forming fibres are arranged in bulges in the housing structure. The signal emitter-forming fibres may be more susceptible to bending loads than to tensile loads. Therefore, detectable signs of failure of the fibres may occur earlier under bending loads. In particular, a tank for holding fluids may have bulges towards the ends thereof, for example. If the signal emitter fibres are arranged in the bulging regions, the susceptibility of the fibres to bending loads can be exploited to enable early detection of critical statuses of the housing structure. In particular, the signal emitter fibres may be arranged lengthwise along the bend.

In a further development of the invention, the housing structure is a battery cover of a motor vehicle. To enable early detection of damage to the battery and/or the underbody cover of a motor vehicle, at least one, preferably multiple structure-borne sound sensors is/are arranged on the underbody cover, by means of which vibrations propagating in and on the underbody cover can be captured. The signal emitters may be embedded in the battery cover and may contribute to the generation and distinguishability of the structure-borne sound signal patterns, so that a reliable distinction can be made between different damage events. The signal emitters may also generate structure-borne sound signal patterns for critical states of the battery, which can be captured. For example, the signal emitter fibres may be affected as well in the event of fractures of the housing structure or also if the housing structure is exposed to heavy impacts on the structure-forming fibres. The damage to the signal emitter fibres can be detected early. A further aspect of the invention relates to a motor vehicle with a housing structure according to the invention.

### BRIEF DESCRIPTION OF THE DRAWINGS

In the following text, the invention will be explained in greater detail with reference to an embodiment represented in the drawing. In detail, the schematic illustration shows in:

FIG. 1: a housing structure according to the invention embodied as a tank with acoustic signal emitters and a sensor assembly; and

FIG. 2: a housing structure according to the invention embodied as a battery cover with acoustic signal emitters and a sensor assembly.

### DETAILED DESCRIPTION

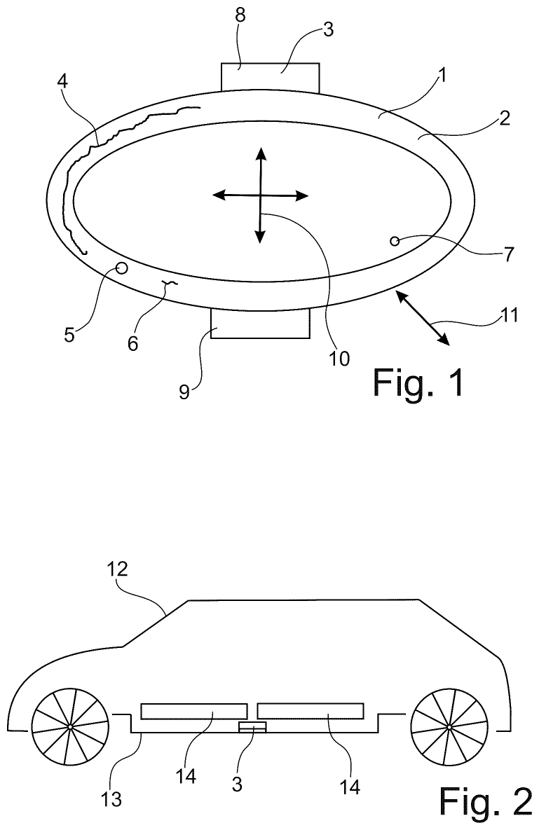

FIG. 1 represents a housing structure 1 with a wall 2, a sensor assembly 3 and acoustic signal emitters 4-6. The wall of the housing structure 1 is formed here the outer casing and consists of a fibre composite material, such as for example glass fibre-reinforced plastics or carbon fibre-reinforced plastics. A possible inner casing, which may be surrounded by the outer casing, is not represented. The housing structure 1 is provided for holding a medium 7, in particular a gas-phase, liquid or solid medium. The sensor assembly 3 is formed by the central control unit 8 and a transmitter unit 9. The central control unit 8 and the transmitter unit 9 each include at least one piezoelectric element for capturing the vibrations propagating on the wall 2.

The central control unit 8 may be designed to send out structure-borne sound signals, with which the transmitter unit 9 can be actuated. Here, it is represented schematically that a signal emitter 4 may be a fibre composite, an acoustic signal emitter 5 may be a sphere, made for example of plastic or glass, and an acoustic signal emitter 6 may be a single fibre. When the fluid volume contained in the tank changes, the wall 2 expands or contracts, represented here by the arrows 10. For example, when a gas is held in the housing structure 1, the wall 2 may be expanded, with the result that structure- borne sound signals are generated on the wall 2. In this process, characteristic structure-borne sound signal patterns may be generated by the acoustic signal emitters 4-6 and captured by the sensor assembly 3. Impacts from the outside on the housing structure 1, represented symbolically here by the arrow 11, can also be captured via the structure-borne sound signals generated thereby. The material properties of the signal emitter fibres 6 can be chosen such that for critical statuses, of the housing structure the signal emitter fibres 6 indicate the signs of damage before the structure-forming fibres and transmit corresponding structure-borne sound signals. These signs of damage can be detected early from the structure-borne sound signals by means of the structure-borne sound system, before the structure-forming fibres also break and the housing structure sustains damage.

FIG. 2 represents a housing structure 13 of a motor vehicle 12 embodied as battery cover. The batteries 14 are covered on the underfloor by the housing structure 13t. The housing structure 13 is associated with the sensor assembly 3. Signal emitters 4-6 are embedded in the housing structure 13.

1. A method for monitoring the structure of a housing structure, wherein the housing structure is connected to at least one sensor assembly in a manner conductive of structure-borne sound signals, wherein the sensor assembly includes at least one structure-borne sound sensor for detecting structure-borne sound signals propagating in and on the housing structure, wherein the housing structure includes at least one signal emitter, wherein the at least one signal emitter is embedded in at least one wall of the housing structure, wherein the at least one signal emitter is designed to emit and/or to influence structure-borne sound signals propagating in and on the housing structure, wherein a structure-borne sound signal which is emitted and/or influenced by the signal emitters and propagates in and on the housing structure is detected by means of the sensor assembly, and wherein the structure-borne sound signal captured by means of the sensor assembly is evaluated in order to evaluate the condition of the housing structure.

2. The method according to claim 1, wherein the housing structure is designed to hold fluid or solid media, that at least one structure-borne sound signal which is influenced and/or produced by the signal emitters and propagates in and on the housing structure is captured for a known fill level of the housing structure and stored as reference value.

3. The method according to claim 1, wherein the housing structure is a battery cover of a motor vehicle.

4. The method according to claim 1, wherein characteristic structure-borne sound signal patterns are emitted by the signal emitters at critical statuses of the housing structure, and that when a characteristic structure-borne sound signal pattern is detected a conclusion is drawn regarding the critical status of the housing structure.

5. The method according to claim 1, wherein at least one recorded structure-borne sound signal is compared with at least one reference value, and that a warning signal is output when deviations are detected.

6. The method according to claim 1, wherein at least the characteristic structure-borne sound signal patterns influenced and/or produced by the signal emitters are filtered out from a background noise.

7. The method according to claim 1, wherein the signal emitters are fibres, and that the fibres are made from at least similar, in particular from the same material as fibres from which the housing structure is manufactured.

8. The method according to claim 1, wherein the fibres forming the signal emitters have a lower tensile strength and/or a higher tensile E-Modul and/or a lower strain at failure than the fibres from which the housing structure is constructed.

9. The method according to claim 1, wherein the signal emitters are glass fibres and/or carbon fibres and/or glass beads and/or plastic beads and/or acoustic fibres.

10. A housing structure, with at least one wall, wherein at least one signal emitter is embedded in the wall, and wherein the at least one signal emitter is designed to emit and/or to influence structure-borne sound signals propagating in and/or on the housing structure.

11. The housing structure according to claim 10, wherein the housing structure includes at least one sensor assembly for detecting structure-borne sound signals that are influenced and/or produced by the signal emitters and propagating in and on the housing structure (1).

12. The housing structure according to claim 10, wherein the at least one wall consists of a fibre-reinforced composite material.

13. The housing structure according to claim 10, wherein the signal emitters are fibres, and that the fibres are made from an at least similar, in particular from the same material as fibres from which the housing structure is manufactured.

14. The housing structure according to claim 10, wherein the fibres forming the signal emitters (6) have a lower tensile strength and/or a higher tensile E-Modul and/or a lower strain at failure than the fibres that form the housing structure.

15. The housing structure according to claim 10, wherein the signal emitters are glass fibres and/or carbon fibres and/or glass beads and/or plastic beads and/or acoustic fibres.

16. The housing structure according to claim 10, wherein the sensor assembly includes a central control unit, that the central control unit is designed to produce and receive structure-borne sound signal patterns, that the sensor assembly includes at least one transmitter unit, that the transmitter unit is arranged spatially separately from the central control unit, that the at least one transmitter unit is designed to produce and receive structure-borne sound signal patterns, and that the central control unit includes at least one evaluation device for evaluation of the structure-borne sound signal patterns transmitted by the transmitter units.

17. The housing structure according claim 10, wherein the housing structure is designed to hold fluid or solid media.

18. The housing structure according claim 10, wherein the fibres that form the signal emitters are arranged in bulges in the housing structure.

19. The housing structure according to claim 10, wherein the housing structure is a battery cover of a motor vehicle.

20. A motor vehicle with the housing structure according to claim 10.
